(19) United States
(12) Patent Application Publication
(10) Pub. No.: US 2019/0160497 A1
(43) Pub. Date: May 30, 2019

(54) HOT WATER PRESSURE WASHER

(71) Applicants: Jeremy Sanger, Milford, MI (US); Franco Garavoglia, Walled Lake, MI (US)

(72) Inventors: Jeremy Sanger, Milford, MI (US); Franco Garavoglia, Walled Lake, MI (US)

(21) Appl. No.: 15/826,532

(22) Filed: Nov. 29, 2017

(51) Int. Cl. B08B 3/02; B05B 9/00

(52) U.S. Cl. CPC B08B 3/028; B05B 9/0403; B05B 9/002

(57) ABSTRACT

A hot water pressure washer employs a high-pressure pump for generating a stream of high pressure fluid and a hydrodynamic heater operable for heating the fluid stream. The hydrodynamic heater includes an inlet port fluidly connectable to a fluid source and an outlet port fluidly connected to an inlet port of the high-pressure washer. An outlet port of the high-pressure washer is connectable to a handheld wand operable for discharging the fluid stream to atmosphere. A prime-mover provides rotational torque for driving the hydrodynamic heater and the high-pressure pump. An unloader valve is used to control distribution of the fluid stream discharged from the high-pressure pump. An exhaust gas recovery heat exchanger operates to transfer heat from the prime-mover exhaust gas to the fluid stream. A pre-heat tank is used to temporarily store a quantity of heated fluid for future use.

### BACKGROUND

Portable pressure washers have been manufactured worldwide for residential and industrial uses. A pressure washer (also known as a power washer) is a high-pressure mechanical sprayer used to remove loose paint, mold, grime, dust, mud, and dirt from surfaces and objects such as buildings, vehicles and concrete surfaces. There are typically two versions of a portable pressure washer design; these being either cold water or hot water machines. The pressure washer may be connected to an existing water supply, such as a garden hose, or may store water in an attached tank. There may be an on/off switch for controlling the water stream and certain models may enable an operator to adjust the water pressure.

The basic components of a portable cold-water power washer include a prime-mover, such as an internal combustion engine or electric motor, mounted on a mobile cart, complete with fuel storage and delivery to the engine. The engine may be coupled to a high-pressure pump, either directly or via a drive mechanism, such as a serpentine belt. The pump may be equipped with an unloader valve that enables an operator to adjust the output performance of the pressurized water stream (i.e., pressure and flow). A high-pressure hose may be attached to an output port of the high-pressure pump and terminated at a handheld ‘wand’ equipped with a trigger-release (i.e., hand valve) that permits the operator to control the flow (on or off) as desired. An inlet port of the high-pressure pump may be fitted with a hose hookup, typically for connection to a garden spigot.

The configuration of the hot water pressure washer may be more complicated than the cold-water power washer due a need to heat the incoming water to a substantial temperature. With typical flow rates of 2-4 gallons per minute (GPM) and a required temperature rise more than 120-140 degrees Fahrenheit, 30-50 kilowatts (kW) of thermal energy may be required on a continuous basis.

The basic components of a portable hot water power washer may include a prime-mover, such as an internal combustion engine, mounted on a mobile cart, complete with fuel storage and delivery to the engine. The engine may be coupled to a high-pressure pump, either directly or via a drive mechanism, such as a serpentine belt. The pump is typically equipped with an unloader valve (i.e., pressure relief valve) that enables the user to adjust the output performance of the pressurized water stream (pressure and flow).

An outlet port of the high-pressure pump may be plumbed to a flame-fired burner assembly. The burner assembly typically incorporates a continuous-coil air-to-water heat exchanger mounted over a gasoline or diesel-fired flame burner. The top of the burner may include an exhaust hood. A high-pressure hose may be attached to an output port of the burner assembly and terminated at a handheld ‘wand’ equipped with a trigger-release (i.e., hand valve) that permits the operator to control the flow (on or off) as desired. An inlet port of the high-pressure pump may be fitted with a hose hookup, typically for connection to a garden spigot.

Due to the complexity of the hot water pressure washer design versus a cold-water pressure washer, the cost of the hot water pressure washer is typically an order of magnitude (5× to 10×) higher than the cost of a cold-water pressure washer. This significant cost variance has hindered successful commercialization of a hot water pressure washer into the consumer and residential markets worldwide.

### SUMMARY

Disclosed is a hot water pressure washer that employs a high-pressure pump for producing a stream of pressurized water and a hydrodynamic heater for heating the water. A prime-mover, such as an internal combustion engine, may be used to generate rotational torque for powering the high-pressure pump and the hydrodynamic heater. The hydrodynamic heater may include an inlet port fluidly connectable to a water source, such as a municipal water supply, and an outlet port fluidly connected to an inlet port of the high-pressure pump. The hot water pressure washer may include an unloader valve that has an inlet port fluidly connected to an outlet port of the high-pressure pump. The unloader valve may have a first outlet port fluidly connected to the inlet port of the hydrodynamic heater through a bypass passage and a second outlet port fluidly connectable to a high-pressure hose. A handheld wand may be attached to the high-pressure hose and include a trigger activated hand valve that may be selectively actuated by an operator to control a stream of water discharged from the handheld wand. The unloader valve may be adjusted to control distribution of the high-pressure water discharged from the high-pressure pump between the bypass passage and the high-pressure hose. The hot water pressure washer may employ an exhaust gas recovery heat exchanger operable to transfer heat from the internal combustion engine exhaust gas to the stream of water passing through the high-pressure power washer. An engine oil cooler may be used to transfer heat from the engine oil to the stream of water. The hot water pressure washer may employ a pre-heat tank for temporarily storing a quantity of heated fluid for future use.

### BRIEF DESCRIPTION OF THE DRAWINGS

The various features, advantages and other uses of the present apparatus will become more apparent by referring to the following detailed description and drawings, in which:

FIG. 1 is side elevational view of a transportable hot water pressure washer;

FIG. 2 is schematic illustration of the hot water pressure washer illustrating fluid connections between device components;

FIG. 3 is a perspective view of a hydrodynamic heater with an integral heat exchanger that may be employed with the hot water pressure washer;

FIG. 4 is a schematic illustration of a fluid network of the hot water pressure washer;

FIG. 5 is a schematic illustration of the fluid network of FIG. 4, with the trigger valve arranged in an open position and an unloader valve arranged to allow maximum fluid flow and pressure;

FIG. 6 is a schematic illustration of the fluid network of FIG. 4, with the trigger valve arranged in the open position and the unloader valve adjusted to an intermediate pressure set point;

FIG. 7 is a schematic illustration of the fluid network of FIG. 4, with the trigger valve arranged in a closed position;

FIG. 8 is a schematic illustration of a fluid network of the hot water pressure washer without the exhaust heat recovery heat exchanger;

FIG. 9 is a schematic illustration of a fluid network of the hot water pressure washer employing an engine oil to water heat exchanger;

FIG. 10 is a schematic illustration of a fluid network of the hot water pressure washer employing a pre-heat tank located downstream of the exhaust heat recovery heat exchanger and upstream of the hydrodynamic heater;

FIG. 11 is a schematic illustration of a fluid network of the hot water pressure washer employing a pre-heat tank without the exhaust heat recovery heat exchanger;

FIG. 12 is a schematic illustration of a fluid network of the hot water pressure washer with the exhaust heat recovery heat exchanger located downstream of the unloader valve;

FIG. 13 is a schematic illustration of a fluid network of the hot water pressure washer employing a pre-heat tank located upstream of the hydrodynamic heater and the exhaust heat recovery heat exchanger located downstream of the unloader valve; and

FIG. 14 is a schematic illustration of a fluid network of the hot water pressure washer employing a pre-heat tank located upstream of the hydrodynamic heater and the exhaust heat recover heat exchanger located upstream of the unloader valve and downstream of a high-pressure pump.

### DETAILED DESCRIPTION

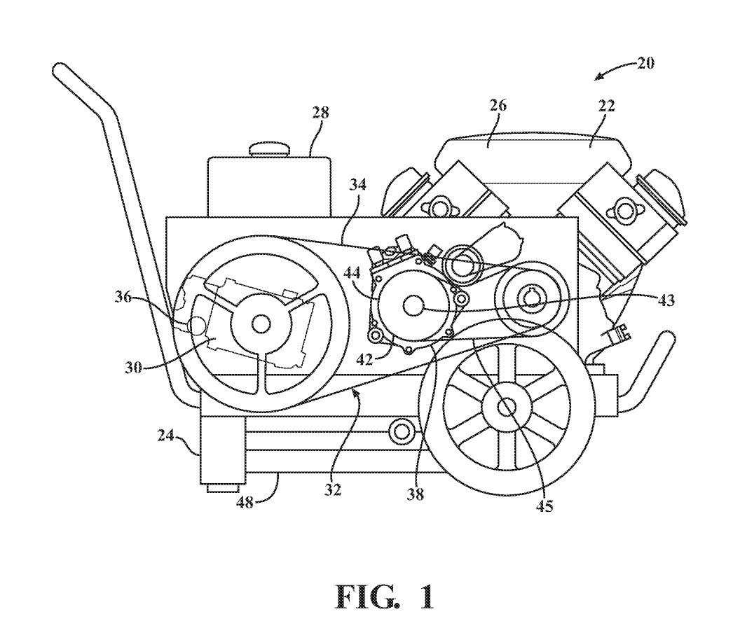

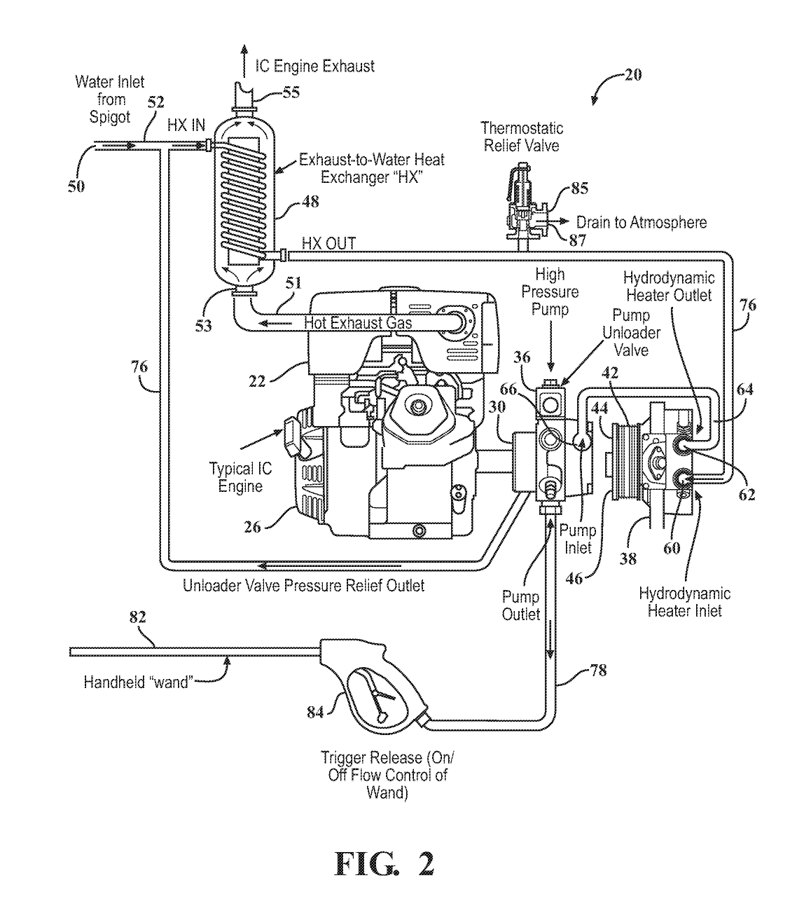

With reference to FIGS. 1 and 2, a portable hot water pressure washer 20 may include a prime-mover 22 mounted on a mobile cart 24. Prime-mover 22 may include an internal combustion engine 26, electric motor, or another device capable of outputting a rotational torque. A fuel tank 28 may be provided for storing and delivering fuel to engine 26. Engine 26 may be operably coupled to a high-pressure pump 30, either directly or via a drive mechanism 32, such as a pump drive belt 34. FIG. 1, for example, illustrates engine 26 operably coupled to high pressure pump 30 via drive mechanism 32, whereas FIG. 2 illustrates engine 26 directly connected to high-pressure pump 30. Hot water pressure washer 20 may be equipped with an operator adjustable unloader valve 36 that enables a user to adjust the output performance of a pressurized water stream, such as pressure and flowrate. Unloader valve 36 may at least partially operate as pressure relief valve.

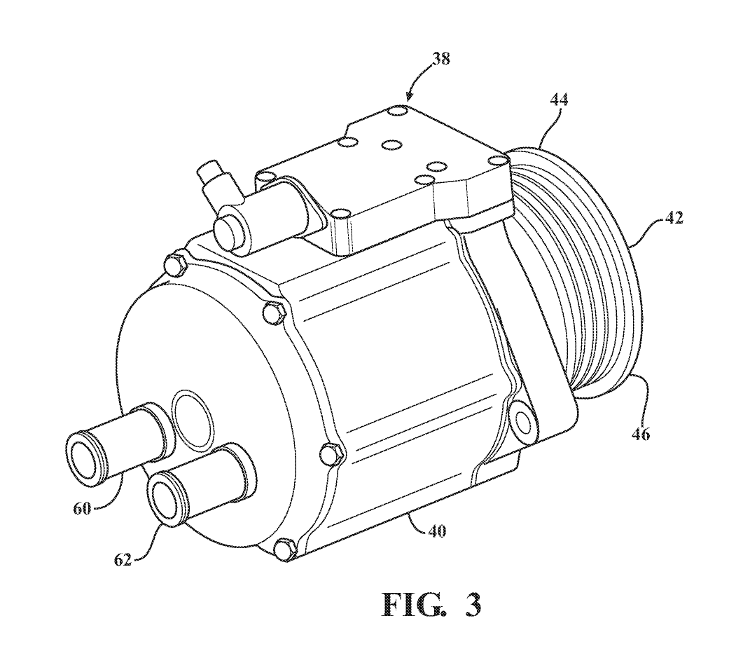

With reference to FIGS. 1-3, internal combustion engine 26 may drive a hydrodynamic heater 38, either directly or via a hydrodynamic heater drive belt 45. FIG. 1, for example, illustrates engine 26 operably coupled to hydrodynamic heater 38 via hydrodynamic heater drive belt 45, whereas FIG. 2 illustrates engine 26 directly connected to hydrodynamic heater 38. Hydrodynamic heater 38 may include an integral heat exchanger 40. Power for operating hydrodynamic heater 38 may be supplied by any of a variety of power sources, including but not limited to internal combustion engine 26.

Hydrodynamic heater 38 may include a drive shaft 43 and a drive means 42 attached to an end of the drive shaft 43. Drive means 42 may include a pulley 44 engageable with the hydrodynamic heater drive belt 45. Hydrodynamic heater drive belt 45 transfers torque generated by internal combustion engine 26 to the drive shaft of the hydrodynamic heater 38. Alternatively, hydrodynamic heater 38 and high-pressure pump 30 may be driven by a single drive belt rather than two separate drive belts.

Drive means 42 may include a clutch 46, which may, for example and without limitation, be an electromagnetic clutch. Clutch 46 may be selectively engaged in response to a user input and/or the particular heating requirements of the hot water pressure washer 20. Clutch 46 may be operated to disengage hydrodynamic heater 38 from the power supply, for example, internal combustion engine 26, when no additional heating of the water is required.

Hot water pressure washer 20 may include an exhaust heat recovery heat exchanger 48 as a second source of heat to the water passing through the pressure washer. Although a suitably sized hydrodynamic heater 38 may negate a need to employ exhaust heat recovery heat exchanger 48, it may be beneficial that hot water pressure washer 20 utilize the smallest displacement of internal combustion engine 26 possible, minimizing the system cost as much as possible. Recovery of heat from the engine's exhaust system is effectively ‘free’ energy to the system, thus providing a measurable benefit from incorporating exhaust heat recovery heat exchanger 48. The exhaust heat recovery heat exchanger 48 may be fluidly connected to an exhaust 51 of engine 26. Exhaust gas from engine 26 may enter the exhaust heat recovery heat exchanger 48 at an exhaust inlet port 53. The exhaust gas may pass through the exhaust heat recovery heat exchanger 48 and be discharged to atmosphere though an exhaust output port 55.

FIGS. 2 and 4 schematically illustrates a fluid path of the water passing through hot water pressure washer 20. Water entering the hot water pressure washer 20 at an inlet 50 may be directed through a supply passage 52 to the exhaust heat recovery heat exchanger 48. The water may enter the exhaust heat recovery heat exchanger at a water inlet port 54. Heat from internal combustion engine 26 exhaust gas passing through exhaust heat recovery heat exchanger 48 may be transferred to the water passing through the exhaust heat recovery heat exchanger 48.

Warmed water may be discharged from exhaust heat recovery heat exchanger 48 at a water outlet port 56 and travel through a hydrodynamic heater supply passage 58 to hydrodynamic heater 38. The warmed water may enter hydrodynamic heater 38 at a heater inlet port 60. The water is further heated as it passes through hydrodynamic heater 38.

Heated water may exit hydrodynamic heater 38 at a heater outlet port 62 and pass through a hydrodynamic heater discharge passage 64 to high-pressure pump 30. The water may enter the high-pressure pump 30 at a pump inlet port 66. High-pressure pump 30 operates to pressurize the water. Pressurized water may be discharged from high-pressure pump 30 at an outlet port 68. Water discharged from high-pressure pump 30 may flow to an unloader valve 36 and enter the valve at a valve inlet port 70.

Unloader valve 36 may include a first outlet port 72 fluidly connected to water inlet port 54 of exhaust heat recover heat exchanger 48 by way of a bypass passage 76. A high-pressure spray hose 78 fluidly connects a second outlet port 80 of the unloader valve 36 to a handheld wand 82 equipped with a trigger-activated hand valve 84 that permits the user to control the flow of heated water discharged from the handheld wand 82. When operating hot water pressure washer 20, the user may cycle triggering of the handheld wand 82 on a periodic basis; perhaps 30-60 seconds engaged, followed by 30-60 seconds disengaged. The unloader valve 36 may be selectively adjusted to control a flow distribution of water between bypass passage 76 and high-pressure spray hose 78. The unloader valve 36 may also operate as a pressure relief valve.

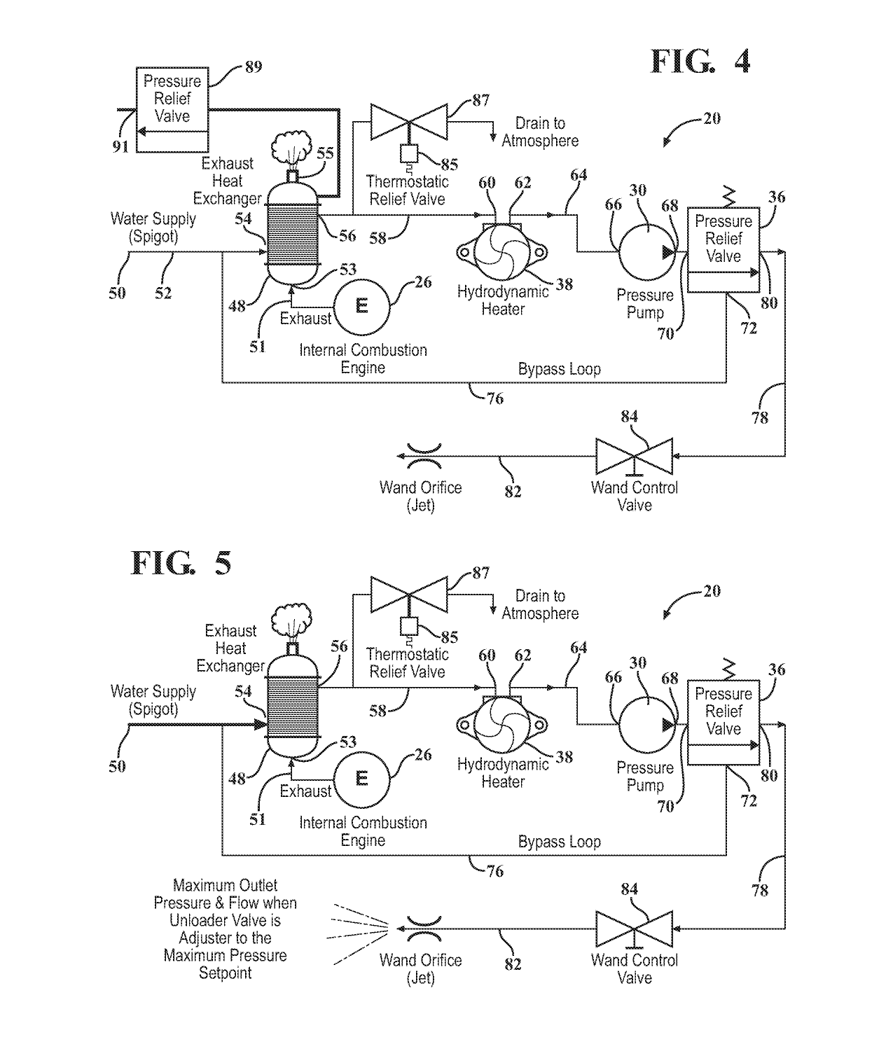

Referring to FIG. 5, with unloader valve 36 adjusted for a maximum outlet pressure and flow, actuating the handheld wand trigger valve 84 causes water to enter exhaust heat recovery heat exchanger 48 from the water source at inlet 50. Thermal energy from the engine 26 exhaust system may be transferred to the water via exhaust heat recovery heat exchanger 48.

Water, at an elevated temperature versus the source water temperature (i.e., temperature of the water at inlet 50), may exit exhaust heat recovery heat exchanger 48 at water outlet port 56 and enter hydrodynamic heater 38 at heater inlet port 60. Water may exit hydrodynamic heater 38 at heater outlet port 62, further elevated in temperature, and enters high-pressure pump 30 at pump inlet port 66. With unloader valve 36 adjusted to provide minimum pressure relief and maximum pump-outlet pressure, substantially all the water leaving high-pressure pump 30 enters high-pressure spray hose 78 and passes through handheld wand 82, while substantially no water leaving high-pressure pump 30 recirculates via unloader valve 36 to exhaust heat recovery heat exchanger 48.

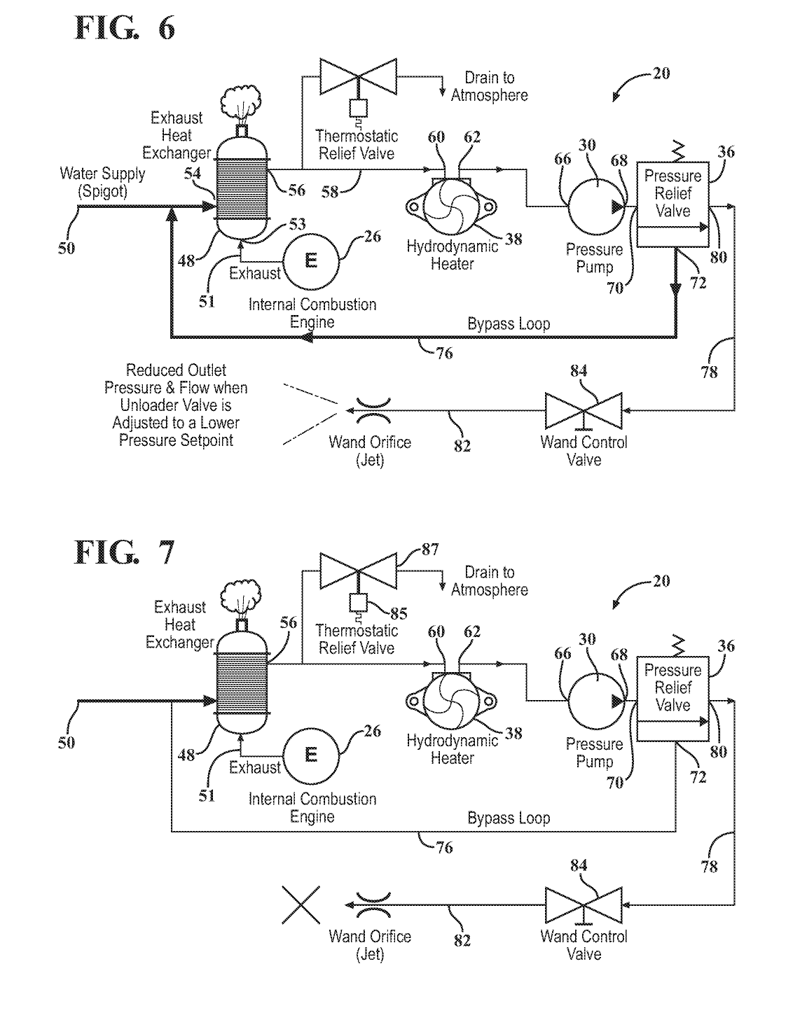

Referring to FIG. 6, with unloader valve 36 adjusted for partial outlet pressure and flow, activating the handheld wand trigger valve 84 causes water to enter fluid inlet 54 of exhaust heat recovery heat exchanger 48 from the water source. Thermal energy from the exhaust system is transferred to the water via exhaust heat recovery heat exchanger 48.

Water, at an elevated temperature versus the source water, exits exhaust heat recovery heat exchanger 48 at outlet port 56 and enters hydrodynamic heater 38 at heater inlet port 60. Water exits hydrodynamic heater 38 at heater outlet port 62, further elevated in temperature, and enters high-pressure pump 30 at pump inlet port 66. Depending on the adjustable setting of unloader valve 36, a portion of the water leaving high-pressure pump 30 at pump outlet port 68 enters high-pressure spray hose 78 and passes through handheld wand 82, while a portion of the water leaving high-pressure pump 30 recirculates, via unloader valve 36, back to water inlet 54 of exhaust heat recovery heat exchanger 48 through bypass passage 76.

With reference to FIG. 7, releasing the handheld wand trigger valve 84 blocks the flow of water from exiting handheld wand 82, which causes unloader valve 36 to direct substantially the entire flow of water discharged from pump 30 back to water inlet port 54 of exhaust heat recovery heat exchanger 48 through bypass passage 76. Water passing through bypass passage 76 may combine with water received from the water source at inlet 50 and enter exhaust heat recovery heat exchanger 38 at water inlet port 54. Thermal energy from the engine 26 exhaust system may be transferred to the water via the exhaust heat recovery heat exchanger 48. Water, at an elevated temperature versus the source water (i.e., temperature of water entering the hot water pressure washer at inlet 50), may exit exhaust heat recovery heat exchanger 48 at water outlet port 56 and enter hydrodynamic heater 38 at heater inlet port 60. Water may exit hydrodynamic heater 38 at heater outlet port 62, further elevated in temperature, and enter high-pressure pump 30 at pump inlet port 66. Because flow exiting handheld wand 82 is substantially completely restricted (i.e., no flow), unloader valve 36 operates to divert substantially all the water discharged from high-pressure pump 30 back to water inlet port 54 of the exhaust heat recovery heat exchanger 48.

With reference to FIGS. 4-7, exhaust heat recovery heat exchanger 48 may be configured to allow a reasonable amount of volume (perhaps 1-3 gallons) within a fluid side of exhaust heat recovery heat exchanger 48 to enable pre-heating of the water within the heat exchanger when high-pressure pump 30 is bypassing the water back to water inlet 54 of exhaust heat recovery heat exchanger 48.

Temporarily blocking the discharge of water from handheld wand 82, determined by the operator's operation of trigger valve 84, enables exhaust heat recovery heat exchanger 48 to substantially pre-heat the water as it continuously circulates through bypass port 72 of unloading valve 36, exhaust heat recovery heat exchanger 48, hydrodynamic heater 38 (further pre-heating the water) and high-pressure pump 30. This ‘bypass loop’ may continue until trigger valve 84 on handheld wand 82 is depressed to allow water to discharge from handheld wand 82 to atmosphere. When the flow to atmosphere is reestablished by actuating trigger valve 84, unloader valve 36 may cease or partially cease bypassing the water through bypass passage 76. The amount of bypass fluid may be determined by the operator's manual adjustment of unloader valve 36.

During extended operation of hot water pressure washer 20, when handheld wand trigger valve 84 is not depressed, the water present within the ‘bypass loop’, may eventually elevate to an undesirable temperature and/or pressure level. Several design features may be incorporated into the hot water pressure washer 20, either individually or in combination, that may optimize safe and efficient operation of the hot water pressure washer 20. For example, as illustrated in FIG. 4, exhaust heat recovery heat exchanger 48 may be equipped with a thermostatic relief valve 85 that monitors a temperature of the water present in the heat exchanger. Alternatively, this feature may be incorporated anywhere within the hydraulic ‘bypass loop’. For example, the thermostatic valve 85 may be located on a water passage of the exhaust heat recovery heat exchanger 48, such as, for example, hydrodynamic heater supply passage 58. An outlet port 87 of the thermostatic valve 85 may be fluidly connected to atmosphere. If a predetermined temperature is reached during operation of hot water pressure washer 20, the thermostatic valve 85 may be configured to open, permitting a substantial volume of water to escape to atmosphere and allowing cold water received from the water source at inlet 50 to enter exhaust heat recovery heat exchanger 48. The flow of cool water into exhaust heat recovery heat exchanger 48 may quickly result in the thermostatic valve 85 closing. This process may repeat whenever a temperature of the water present with the bypass loop reaches a thermostatic valve set-point of the thermostatic valve 85.

Although the following feature may be incorporated anywhere within the hydraulic ‘bypass loop’, an over-pressure prevention feature may be located within exhaust heat recovery heat exchanger 48, as illustrated for example, in FIG. 4. Exhaust heat recovery heat exchanger 48 may be equipped with an unloader valve 89 that monitors a pressure of the water present in the exhaust heat recovery heat exchanger 48. The unloader valve 89 may be located on a water passage of exhaust heat recovery heat exchanger 48. An outlet port 91 of the unloader valve 89 may be fluidly connected to atmosphere. If a predetermined water pressure in a coolant chamber of exhaust heat recovery heat exchanger 48 is reached during operation, the unloader valve 89 may be configured to open, permitting a substantial release of pressure to atmosphere. The unloader valve 89 may remain in an open position until such time that the pressure within the exhaust heat recovery heat exchanger 48 is released.

With reference to FIGS. 1-3, hydrodynamic heater 38 may be equipped with clutch mechanism 46. The clutch mechanism 46 may be configured such that hydrodynamic heater 38 would be rotating and operating during normal operation. Normal operation is when the water temperature is below a selected temperature set-point that may be detected by a temperature measurement device, such as a thermocouple. During operation, if the water temperature exceeds a selected temperature set-point, the clutch mechanism 46 can disengage. Disengagement of the clutch mechanism 46 produces two effects on the system that may minimize thermal energy being added to the water passing through hot water pressure washer 20. First, disengagement of the clutch mechanism 46 will cease heat generation from hydrodynamic heater 38. Second, disengagement of the clutch mechanism 46 will remove the mechanical load associated with hydrodynamic heater 38 from the prime-mover 22 (i.e., internal combustion engine 26). The release of the mechanical load from internal combustion engine 26 may dramatically reduce the exhaust gas temperature, which may significantly diminish the thermal output of exhaust heat recovery heat exchanger 48.

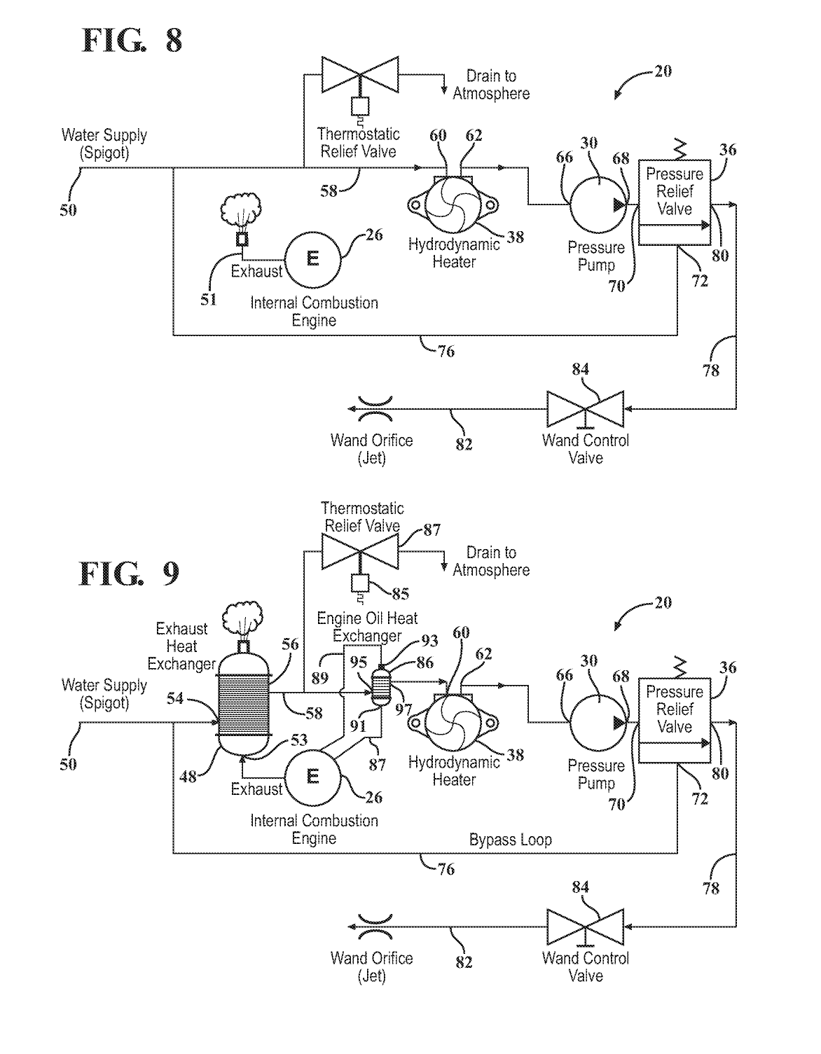

Hot water pressure washer 20 may include various alternative configurations. For example, with reference to FIG. 8, certain applications may not employ exhaust heat recovery heat exchanger 48. Water entering the system from the water supply at inlet 50 may be transported to the hydrodynamic heater 38 through hydrodynamic heater supply passage 58, which may be directly connected to the water source.

With reference to FIG. 9, the hot water pressure washer 20 may employ an engine oil cooler 86. The engine oil cooler 86 may be employed with or without exhaust heat recovery heat exchanger 48. The engine oil cooler 86 may be fluidly connected to internal combustion engine 26 through an oil cooler inlet passage 87 at an oil inlet port 91 and an engine oil cooler outlet passage 89 at an oil outlet port 93. Engine oil from internal combustion engine 26 enters the engine oil cooler 86 through oil cooler inlet passage 87 and may be returned to the internal combustion engine 26 through oil cooler outlet passage 89. The engine oil cooler 86 may be integrated into the power washer water heating circuit. Water traveling through hydrodynamic heater supply passage 58 may enter the oil cooler at a water inlet port 95 and pass through the engine oil cooler 86 to allow heat from engine oil to be transferred to the water. The warmed water may exit the engine oil cooler 86 at a water outlet port 97.

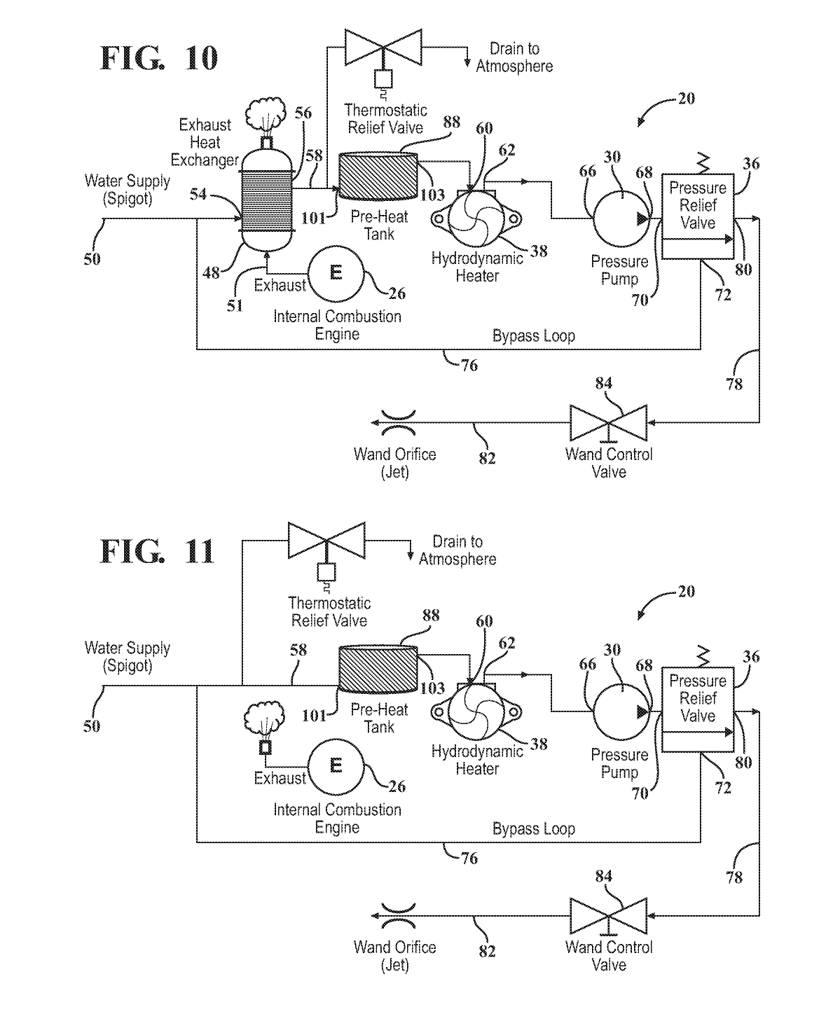

The hot water pressure washer 20 may employ an inline pre-heat tank 88 fluidly integrated within the ‘bypass loop’ in conjunction with, or in place of, the exhaust heat recovery heat exchanger 48, as illustrated, for example, in FIGS. 10, 11, 13 and 14 respectively. The pre-heat tank 88 may, for example, be fluidly connected to hydrodynamic heater supply passage 58 at an inlet port 101 and an outlet port 103. The pre-heat tank 88 may be used to temporarily store a volume of heated water. The water storage capacity of the pre-heat tank may be varied for a particular application. For configurations employing the exhaust heat recovery heat exchanger 48, water discharged from exhaust heat recovery heat exchanger 48 may pass through the pre-heat tank 88 and onto hydrodynamic heater 38 through hydrodynamic heater supply passage 58, as illustrated, for example, in FIG. 10. For configurations not employing the exhaust heat recovery heat exchanger 48, water received from the water source at inlet 50 may pass directly to the pre-heat tank 88 and onto hydrodynamic heater 38 through hydrodynamic heater supply passage 58, as illustrated, for example, in FIG. 11.

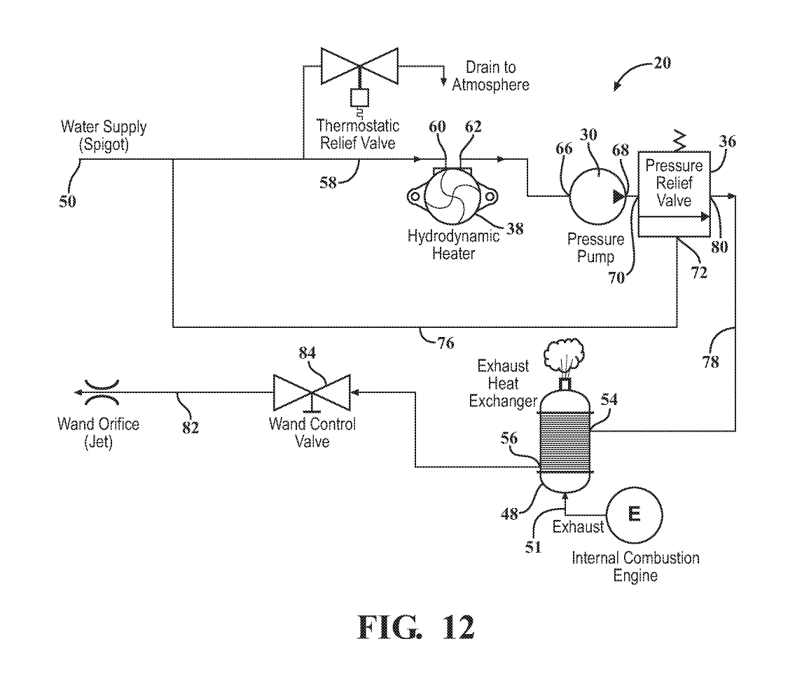

With reference to FIG. 12, for configurations of the hot water pressure washer 20 employing exhaust heat recovery heat exchanger 48, the heat exchanger may alternatively be located downstream of high-pressure pump 30. For example, the exhaust heat recovery heat exchanger 48 may be fluidly integrated into spray hose 78, such that water discharged from unloader valve 36 at outlet port 80 passes through the exhaust heat recovery heat exchanger 48 before passing through handheld wand 82.

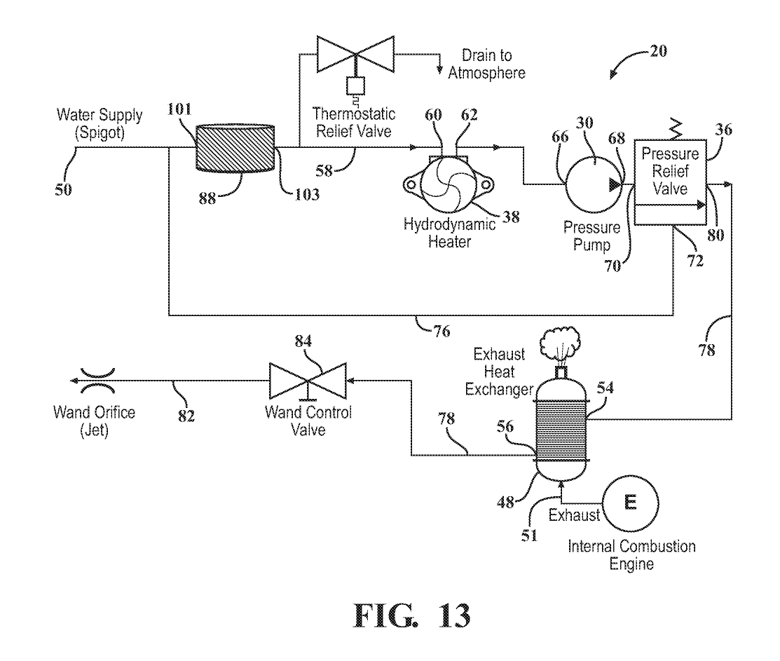

Configurations of the hot water pressure washer 20 having the exhaust heat recovery heat exchanger 48 located downstream of high-pressure pump 30 (as illustrated, for example, in FIG. 12) may include the pre-heat tank 88 fluidly integrated into hydrodynamic heater supply passage 58, as illustrated, for example, in FIG. 13. Water received from the water source at inlet 50 may pass directly to the pre-heat tank 88 and onto hydrodynamic heater 38 through hydrodynamic heater supply passage 58. The exhaust heat recovery heat exchanger 48 may be located downstream of both the high-pressure pump 30 and the unloader valve 36 and fluidly integrated into spray hose 78, such that water discharged from unloader valve 36 at outlet port 80 passes through the exhaust heat recovery heat exchanger 48 before passing through handheld wand 82.

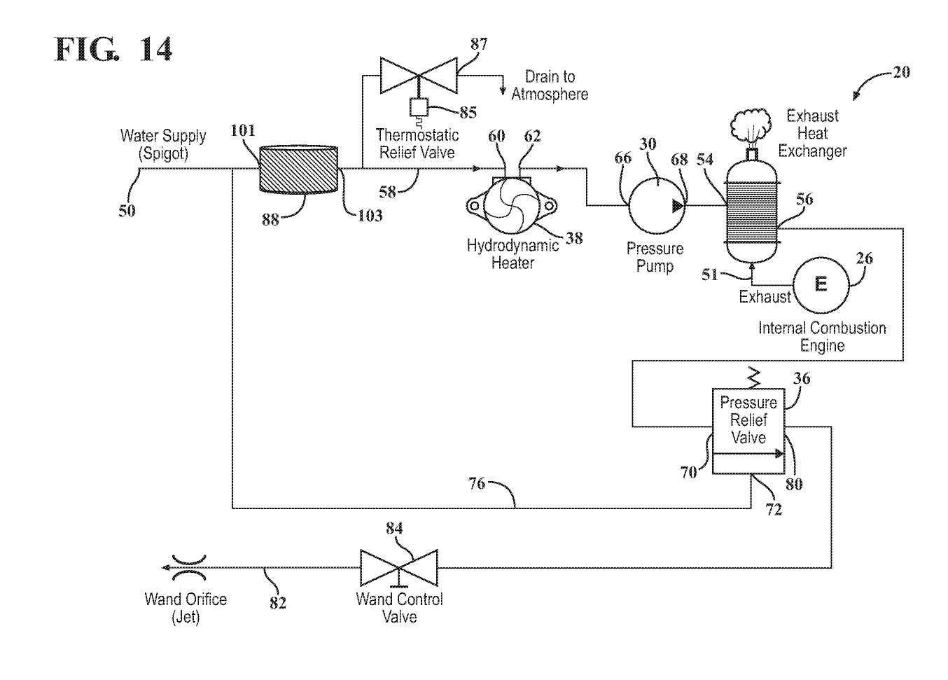

With reference to FIG. 14, the exhaust heat recovery heat exchanger 48 may be fluidly coupled between the high-pressure pump 30 and the unloader valve 36. In this arrangement the water inlet port 54 of the exhaust heat recovery heat exchanger 48 may be fluidly coupled to the pump outlet port 68 of the high-pressure pump 30. The water outlet port 56 of the exhaust heat recovery heat exchanger 48 may be fluidly connected to the valve inlet port 70 of the unloader valve 38. The first outlet port 72 may be fluidly connected to the inlet port 101 of the pre-heat tank 88 and the second outlet port 80 may be fluidly connected to the high-pressure hose 78. The outlet port 103 of the pre-heat tank 103 may be fluidly connected to the heater inlet port 60 of the hydrodynamic heater 38 and the heater outlet port 62 of the hydrodynamic heater 38 may be fluidly connected to the pump inlet port 66 of the high-pressure pump 30.

Hot water pressure washer 20 may employ a water-cooled internal combustion engine, similar to internal combustion engine 26, as prime-mover 22. Thermal energy may be extracted from an engine cooling circuit used to cool the water-cooled internal combustion engine and combined with the power washer water heating circuit.

It is intended that the scope of the present methods and apparatuses be defined by the following claims. However, it must be understood that the disclosed systems and methods may be practiced otherwise than is specifically explained and illustrated without departing from its spirit or scope. It should be understood by those skilled in the art that various alternatives to the configurations described herein may be employed in practicing the claims without departing from the spirit and scope as defined in the following claims. The scope of the disclosed systems and methods should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future examples. Furthermore, all terms used in the claims are intended to be given their broadest reasonable constructions and their ordinary meanings as understood by those skilled in the art unless an explicit indication to the contrary is made herein. In particular, use of the singular articles such as “a,” “the,” “said,” etc., should be read to recite one or more of the indicated elements unless a claim recites an explicit limitation to the contrary. It is intended that the following claims define the scope of the device and that the method and apparatus within the scope of these claims and their equivalents be covered thereby. In sum, it should be understood that the device is capable of modification and variation and is limited only by the following claims.

1. A pressure washer comprising:
a hydrodynamic heater operable for heating a fluid, the hydrodynamic heater including an inlet port fluidly connectable to a fluid source;
a high-pressure pump including an inlet port fluidly connected to an outlet port of the hydrodynamic heater and an outlet port fluidly connectable to a handheld wand selectively operable for discharging a steam of fluid; and
a prime-mover operably connected to at least one of the hydrodynamic heater and the high-pressure pump, the prime-mover operable to generate a rotational torque for powering at least one of the hydrodynamic heater and the high-pressure pump.

2. A hot water pressure washer comprising:
a hydrodynamic heater operable for heating a fluid, the hydrodynamic heater including an inlet port fluidly connectable to a fluid source;
a high-pressure pump including an inlet port fluidly connected to an outlet port of the hydrodynamic heater and an outlet port fluidly connectable to a handheld wand selectively operable for discharging a steam of fluid;
a prime-mover operably connected to at least one of the hydrodynamic heater and the high-pressure pump, the prime-mover operable to generate a rotational torque for powering at least one of the hydrodynamic heater and the high-pressure pump; and
an exhaust heat recovery heat exchanger including a water outlet port fluidly connected to the inlet port of the hydrodynamic heater, a water inlet port fluidly connected to the outlet port of the high-pressure pump and an exhaust gas inlet port fluidly connected to an exhaust of the prime-mover.

3. The pressure washer of claim 2, wherein the water inlet port of the exhaust heat recovery heat exchanger is fluidly connectable to the water source.

4. The pressure washer of claim 2, wherein the water outlet port of the exhaust heat recovery heat exchanger is fluidly connectable to the handheld wand.

5. The pressure washer of claim 2 further comprising an unloader valve having an inlet port fluidly connected to the outlet port of the high-pressure pump and an outlet port fluidly connected to the water inlet port of the exhaust heat recovery heat exchanger.

6. The pressure washer of claim 5, where the unloader valve includes a second outlet port fluidly connectable to the handheld wand.

7. The pressure washer of claim 5 further comprising a pre-heat tank having an inlet port fluidly connected to the water outlet port of the exhaust heat recovery heat exchanger and an outlet port fluidly connected to the inlet port of the hydrodynamic heater.

8. The pressure washer of claim 2 further comprising an unloader valve having an inlet port fluidly connected to the water outlet port of the exhaust heat recovery heat exchanger and an outlet port fluidly connected to the inlet port of the hydrodynamic heater.

9. The pressure washer of claim 8, wherein the unloader valve includes a second outlet port fluidly connectable to the handheld wand.

10. The pressure washer of claim 8 further comprising a pre-heat tank having an inlet port fluidly connected to the outlet port of the unloader valve and an outlet port fluidly connected to the inlet port of the hydrodynamic heater.

11. The pressure washer of claim 2 further comprising an engine oil cooler having an oil inlet port fluidly connected to the prime-mover, an oil outlet port fluidly connected to the prime-mover, a water inlet port fluidly connected to the water outlet port of the exhaust heat recovery heat exchanger and a water outlet port fluidly connected to the inlet port of the hydrodynamic heater.

12. The pressure washer of claim 2 further comprising a pre-heat tank having an inlet port fluidly connected to the outlet port of the high-pressure pump and an outlet port fluidly connected to the inlet port of the hydrodynamic heater.

13. The pressure washer of claim 12, wherein the exhaust heat recovery heat exchanger includes a water inlet port fluidly connected to the outlet port of the high-pressure pump, a water outlet port fluidly connected to the inlet port of the pre-heat tank and an exhaust gas inlet port fluidly connected to an exhaust of the prime-mover.

14. The pressure washer of claim 7 further comprising an unloader valve having an inlet port fluidly connected to the outlet port of the high-pressure pump, a first outlet port fluidly connected to the water inlet port of the exhaust heat recovery heat exchanger and a second outlet port fluidly connectable to the handheld wand.

15. The pressure washer of claim 7 further comprising an unloader valve having an inlet port fluidly connected to the water outlet port of the exhaust heat recovery heat exchanger, a first outlet port fluidly connected to the inlet port of the pre-heat tank and a second outlet fluidly connectable to the handheld wand.

16. The pressure washer of claim 1 further comprising an unloader valve having an inlet port fluidly connected to the outlet port of the high-pressure pump and an outlet port fluidly connected to an inlet port of the hydrodynamic heater.

17. The pressure washer of claim 16, wherein the unloader valve includes a second outlet port fluidly connectable to the handheld wand.

18. The pressure washer of claim 8 further comprising a thermostatic relief valve having an inlet port fluidly connected to the outlet port of the unloader valve and an outlet port fluidly connected to atmosphere.

19. The pressure washer of claim 2, wherein the outlet port of the high-pressure pump is fluidly connected to the inlet port of the hydrodynamic heater.

20. The pressure washer of claim 2 further comprising a thermostatic relief valve having an inlet port fluidly connected to the outlet port of the high-pressure pump and an outlet port fluidly connected to atmosphere.

21. The pressure washer of claim 1 further comprising an exhaust heat recovery heat exchange including a water inlet port fluidly connected to the outlet port of the high-pressure pump, a water outlet port fluidly connectable to the handheld wand and an exhaust gas inlet port fluidly connected to an exhaust of the prime-mover.
